(19) United States
(12) Patent Application Publication
(10) Pub. No.: US 2008/0030153 A1
(43) Pub. Date: Feb. 7, 2008

(54) LIGHTING DEVICE

(75) Inventor: Jun MIZUNO, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Kyoto (JP)

(21) Appl. No.: 11/835,045

(22) Filed: Aug. 7, 2007

(30) Foreign Application Priority Data
Aug. 7, 2006 (JP) 2006-214787

(51) Int. Cl. H05B 41/36

(52) U.S. Cl. 315/360

(57) ABSTRACT

An illumination device that can adjust the chromaticity and brightness of the illuminating light in a broad range using a simple construction includes a first LED and a second LED having mutually different color temperatures, and a control circuit arranged to perform lighting and extinguishing control of the first and second LEDs. The control circuit performs periodic lighting and extinguishing control of the first and second LEDs such that during a lighting period, the first and second LEDs are lit and extinguished in a complementary manner, and during an extinguishing period, both the first and second LEDs are extinguished.

### BACKGROUND OF THE INVENTION

1. Field of the Invention

The present invention relates to an illumination device using a light-emitting diode (hereafter referred to as an “LED”) as a light source, and more particularly relates to color adjustment and brightness adjustment of an illuminating light.

2. Description of the Related Art

In Japanese Laid-Open Patent Application No. 2002-324685, as shown in FIG. 10 (corresponding to FIG. 1 in Japanese Laid-Open Patent Application No. 2002-324685), an illumination device is disclosed in which the level of the current that is supplied to a white LED 15 is controlled by a current value control circuit 12 and an LED driving current supply 11, and the ratio of the “on” time and “off” time of the current supplied to the white LED 15 is controlled by a switch 14, a duty ratio control circuit 16 and a PWM (pulse width modulation) generating circuit 13, so that the chromaticity and brightness of the illuminating light of the white LED 15 can be adjusted.

Japanese Laid-Open Patent Application No. 2005-101296 discloses a variable color light-emitting diode element including a first white light-emitting element that contains a first LED chip, and a second white light-emitting element which contains a second LED chip, and in which the correlated color temperature of the color of the emitted light is lower than that of the first white light-emitting element by 2,000 K or greater, wherein these two types of white light-emitting elements are wired and molded so that the emission of light can be independently controlled.

Japanese Laid-Open Patent Application No. 2004-111104 discloses an LED lighting device including a first light-emitting means, a second light-emitting means in which the color of the emitted light differs from that of the first light-emitting means, and a control means which controls the first and second light-emitting means, wherein the control means lights the first light-emitting means as the main lighting means during full lighting, lights the second light-emitting means as the main lighting means during lighting adjustment, sets the color of the emitted light of either the first or second light-emitting means as white, and continuously varies the brightness and color of the emitted light during full lighting, and the brightness and color of the emitted light during lighting adjustment.

Japanese Publication No. 2003-019072 discloses an LED lamp including a white LED which is set at a specified color temperature, and a correction color LED which has a peak wavelength in a specified wavelength region with respect to this, wherein this lamp is constructed so that the set color temperature of the white LED can be adjusted by the proportion of color mixing of the white LED and correction color LED.

Japanese Laid-Open Patent Application No. 2004-327518 discloses a white light-emitting device in which a blue light-emitting diode is used as a light source, a fluorescent layer is attached to the surface of this light-emitting diode, the fluorescent layer is formed by uniformly mixing a transparent resin and fluorescent powders of two colors, i.e., red and green, the red fluorescent body in the fluorescent layer is excited by blue light, and emits light having a different light emission spectrum (wavelength) from blue light, the green fluorescent body is excited by blue light, and emits light having a different light emission spectrum (wavelength) from blue light, and white light is formed by mixing, which is accomplished by adding a blue light spectrum, a portion of which is not absorbed, to these two different light emission spectra (wavelengths).

To be sure, the chromaticity and brightness of the illuminating light of the white LED can be adjusted using the conventional technique of Japanese Laid-Open Patent Application No. 2002-324685.

However, the conventional technique of Japanese Laid-Open Patent Application No. 2002-324685 is entirely a technique for correcting the chromaticity of the illuminating light by controlling the driving current of the white LED 15. With regard to the chromaticity adjustment range, as is shown in FIG. 2 of Japanese Laid-Open Patent Application No. 2002-324685 (a diagram showing one example of the forward current—chromaticity characteristics of the white LED), this range is not necessarily broad (i.e., this range is an adjustment range of approximately 0.01 to 0.02 in terms of chromaticity coordinates).

Furthermore, in the conventional technique of Japanese Laid-Open Patent Application No. 2002-324685, both the driving current and the “on” duty of the white LED 15 must be controlled in order to adjust the chromaticity and brightness (luminosity) of the illuminating light of the white LED 15. As a result, this control is complicated.

Moreover, the conventional techniques of Japanese Publication No. 2003-019072, Japanese Laid-Open Patent Application No. 2004-111104, and Japanese Laid-Open Patent Application No. 2005-101296 are entirely techniques which realize only an adjustment of the chromaticity of the illuminating light; there is no disclosure regarding adjustment of the brightness of the illuminating light.

In addition, the conventional technique of Japanese Laid-Open Patent Application No. 2004-327518 is entirely a technique for obtaining white light that is superior in terms of color reproducibility, with no danger of color attenuation at a high intensity. However, there is no disclosure regarding adjustment of the chromaticity or adjustment of the brightness of the illuminating light.

### SUMMARY OF THE INVENTION

In order to overcome the problems described above, preferred embodiments of the present invention provide an illumination device which makes it possible to adjust the chromaticity and brightness of the illuminating light in a broad range using a simple construction.

An illumination device according to a preferred embodiment of the present invention includes a first light-emitting element and a second light-emitting element which have mutually different color temperatures, and a control circuit that is arranged to perform lighting and extinguishing control of the first light-emitting element and second light-emitting element, wherein the control circuit is arranged to perform lighting and extinguishing control of the first light-emitting element and second light-emitting element such that during a lighting period in which the first light-emitting element and second light-emitting element are lit and extinguished in a complementary manner, and during an extinguishing period, the first light-emitting element and second light-emitting element are both extinguished.

The control circuit preferably is arranged to variably control the ratio of the lighting period of the first light-emitting element and the lighting period of the second light-emitting element within the lighting period described above in accordance with chromaticity control signals.

The control circuit preferably is arranged to variably control the length of the extinguishing period in accordance with brightness control signals while maintaining the length of the lighting period at a constant value.

Alternatively, the control circuit is preferably arranged to variably control the ratio of the lighting period and the extinguishing period within a specified lighting and extinguishing period in accordance with brightness control signals.

In addition, each of the first light-emitting element and second light-emitting element may preferably comprise a blue light-emitting diode that emits blue light and a fluorescent layer that covers the blue light-emitting diode. The fluorescent layer is preferably formed by uniformly mixing a red fluorescent body and a green fluorescent body that are excited by blue light and that respectively emit red light and green light with a transparent resin, or by uniformly mixing a yellow fluorescent body that is excited by blue light and that emits yellow light with a transparent resin.

The illumination device according to various preferred embodiments of the present invention makes it possible to adjust the chromaticity and brightness of the illuminating light in a broad range using a simple construction.

Other features, elements, steps, characteristics and advantages of the present invention will be described below with reference to preferred embodiments thereof and the attached drawings.

### BRIEF DESCRIPTION OF THE DRAWINGS

FIG. 1 is a block diagram illustrating a preferred embodiment of the illumination device of the present invention.

FIG. 2 is a longitudinal sectional view schematically illustrating the structures of a first LED and a second LED.

FIGS. 3A-3C are diagrams illustrating the chromaticity adjustment operation of the illuminating light.

FIG. 4 is a diagram illustrating the color temperature variation corresponding to the ratio of the “on” period T2 of the LED 2 with respect to the lighting period Ton (=T1+T2).

FIG. 5 is a chromaticity diagram illustrating the variation in chromaticity corresponding to the ratio of the “on” period T2 of the LED 2 with respect to the lighting period Ton (=T1+T2).

FIGS. 6A-6C are diagrams illustrating one example of the brightness adjustment operation of the illuminating light.

FIG. 7 is a diagram illustrating the variation in the brightness in accordance with the length of the extinguishing period Toff.

FIGS. 8A-8C are diagrams illustrating another example of the brightness adjustment operation of the illuminating light.

FIG. 9 is a diagram illustrating the variation in brightness corresponding to the ratio of the lighting period Ton with respect to the lighting and extinguishing period T.

FIG. 10 is a block diagram showing a conventional example of an illumination device.

### DETAILED DESCRIPTION OF THE PREFERRED EMBODIMENTS

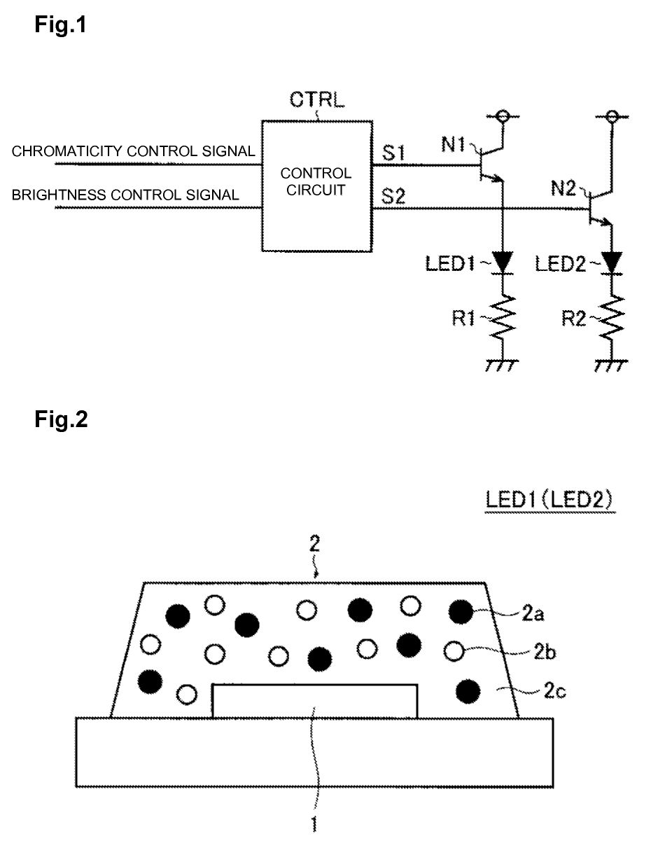

FIG. 1 is a block diagram showing one preferred embodiment of the illumination device of the present invention.

As is shown in this figure, the illumination device of the present preferred embodiment includes a first light-emitting element LED 1, a second light-emitting element LED 2, NPN-type bipolar transistors N1 and N2, resistors R1 and R2, and a control circuit CTRL.

Two types of white light-emitting diodes that have mutually different color temperatures are preferably used as the first light-emitting element LED 1 and second light-emitting element LED 2. Furthermore, in the present preferred embodiment, a white light-emitting diode having a color temperature of about 5,000 K is preferably used as the first light-emitting element LED 1, and a white light-emitting diode having a color temperature of about 2,600 K is preferably used as the second light-emitting element LED 2. However, these color temperatures are merely examples. It is desirable that two types of white light-emitting diodes whose color temperatures are as far apart as possible be used in order to adjust the color temperature (chromaticity) of the illuminating light in a broad range.

The collectors of the transistors N1 and N2 are both connected to the power supply line. The emitter of the transistor N1 is connected to the anode of the first light-emitting element LED 1. The emitter of the transistor N2 is connected to the anode of the second light-emitting element LED 2. The cathode of the first light-emitting element LED 1 is connected to the ground line via the resistor R1. The cathode of the second light-emitting element LED 2 is connected to the ground line via the resistor R2.

The control circuit CTRL is constructed and arranged to perform lighting and extinguishing control of the first light-emitting element LED 1 and second light-emitting element LED 2 by generating switching control signals S1 and S2 that are supplied to the bases of the transistors N1 and N2 on the basis of chromaticity control signals and brightness control signals.

To describe this in more specific terms, when the first light-emitting element LED 1 is to be lit, the switching control signal S1 is set at a high level, and the transistor N1 is switched “on.” As a result of such control, the supply of a driving current to the first light-emitting element LED 1 is permitted, so that the first light-emitting element LED 1 is lit. Conversely, when the first light-emitting element LED 1 is to be extinguished, the switching control signal S1 is set at a low level, and the transistor N1 is switched “off.” As a result of such control, the supply of a driving current to the first light-emitting element LED 1 is cut off, so that the first light-emitting element LED 1 is extinguished.

Similarly, when the second light-emitting element LED 2 is to be lit, the switching control signal S2 is set at a high level, and the transistor N2 is switched “on.” As a result of such control, the supply of a driving current to the second light-emitting element LED 2 is permitted, so that the second light-emitting element LED 2 is lit. Conversely, when the second light-emitting element LED 2 is to be extinguished, the switching control signal S2 is set at a low level, and the transistor N2 is switched “off.” As a result of such control, the supply of a driving current to the second light-emitting element LED 2 is cut off, so that the second light-emitting element LED 2 is extinguished.

Furthermore, the chromaticity adjustment operation and brightness adjustment operation of the illuminating light that are performed by the control circuit CTRL will be described in detail later.

Next, the structures of the first light-emitting element LED 1 and second light-emitting element LED 2 will be described in detail with reference to FIG. 2.

FIG. 2 is a longitudinal sectional view which schematically illustrates the structure of the first light-emitting element LED 1. Furthermore, since the structure of the second light-emitting element LED 2 is also the same, a redundant description is omitted.

As is shown in this figure, the first light-emitting element LED 1 preferably includes a blue light-emitting diode 1 which emits blue light and a fluorescent layer 2 which covers the blue light-emitting diode 1. Furthermore, the fluorescent layer 2 is preferably formed by uniformly mixing a red fluorescent body 2a which is excited by blue light, and which emits red light, and a green fluorescent body 2b which is excited by blue light, and which emits green light, with a transparent resin 2c.

In the first light-emitting element LED 1 constructed as described above, white light with high color rendering properties can be produced by mixing the red light that is emitted by the red fluorescent body 2a, the green light that is emitted by the green fluorescent body 2b, and the portion of the blue light that is not absorbed by these two fluorescent bodies.

Furthermore, in cases where priority is given to the improvement of the light emission efficiency over improvement of the color rendering properties, a construction may be used in which the fluorescent layer 2 is formed by uniformly mixing a yellow fluorescent body which is excited by blue light, and which emits yellow light, with a transparent resin.

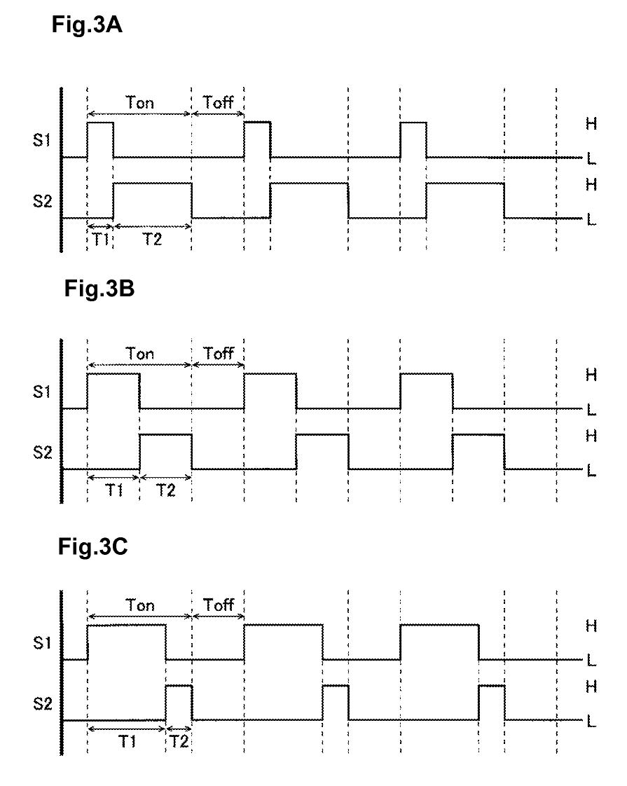

Next, the chromaticity adjustment operation (color temperature adjustment operation) of the illuminating light performed by the control circuit CTRL will be described in detail with reference to FIGS. 3A-3C.

FIGS. 3A-3C are diagrams illustrating the chromaticity adjustment operation of the illuminating light. The symbols S1 and S2 in (a) through (c) of this figure respectively indicate the logical states of the switching control signals S1 and S2 (and by extension, the lit or extinguished states of the LED 1 and LED 2).

As is shown in FIGS. 3A-3C, the control circuit CTRL has a construction which performs periodic lighting and extinguishing control of the first light-emitting element LED 1 and second light-emitting element LED 2 so that this control has a lighting period Ton in which the first light-emitting element LED 1 and second light-emitting element LED 2 are lit and extinguished in a complementary manner (in other words, so that the “on” duty of both light-emitting elements is a total of 100%), and an extinguishing period Toff in which both the first light-emitting element LED 1 and second light-emitting element LED 2 are extinguished.

Furthermore, the control circuit CTRL has a construction which variably controls the ratio of the lighting period T1 of the first light-emitting element LED 1 and the lighting period T2 of the second light-emitting element LED 2 within the lighting period Ton in accordance with input chromaticity control signals.

To describe this in more specific terms, in cases where the color temperature of the illuminating light is to be lowered, the ratio of the lighting period T2 of the second light-emitting element LED 2 with respect to the lighting period Ton (i.e., the “on” duty of the second light-emitting element LED 2) may be successively raised (FIG. 3C→FIG. 3B→FIG. 3A); conversely, in cases where the color temperature of the illuminating light is to be raised, the “on” duty of the second light-emitting element LED 2 may be successively lowered (FIG. 3A→FIG. 3B→FIG. 3C).

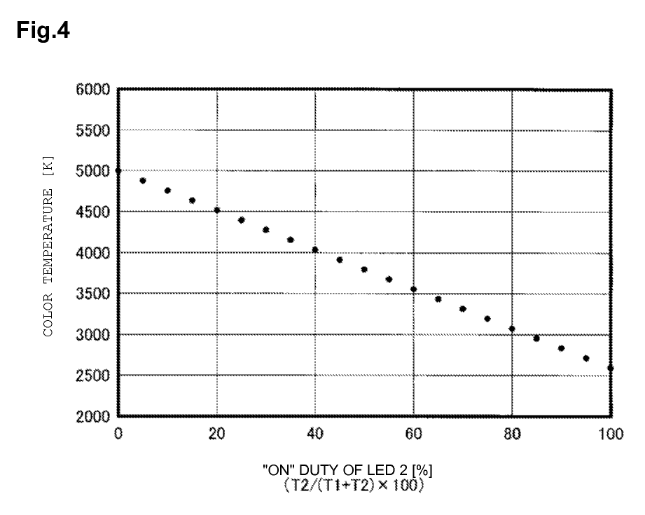

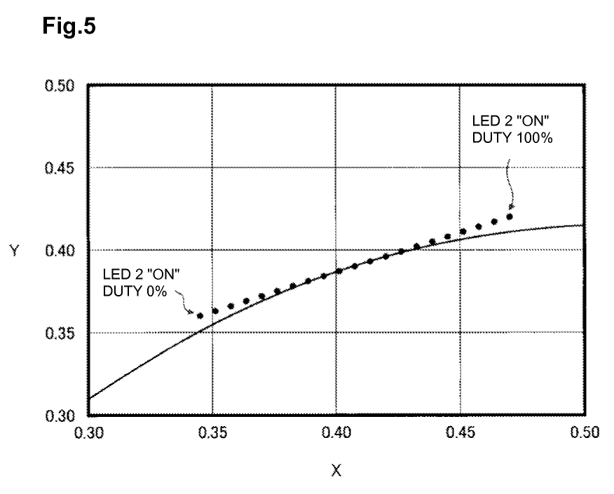

FIG. 4 is a diagram illustrating the color temperature variation corresponding to the ratio of the “on” period T2 of the second light-emitting element LED 2 with respect to the lighting period Ton (=T1+T2). Furthermore, FIG. 5 is a chromaticity diagram illustrating the variation in chromaticity corresponding to the ratio of the “on” period T2 of the second light-emitting element LED 2 with respect to the lighting period Ton (=T1+T2). The solid line in FIG. 5 shows the black body radiation curve.

As is shown in FIG. 4, in the illumination device of the present preferred embodiment, the color temperature of the illuminating light can be continuously adjusted from the color temperature (about 5,000 K) of the first light-emitting element LED 1 to the color temperature (about 2,600 K) of the second light-emitting element LED 2. With regard to the chromaticity of the illuminating light, furthermore, a broad adjustment range of approximately about 0.06 to about 0.14 in terms of chromaticity coordinates can be obtained as shown in FIG. 5.

Accordingly, in the illumination device of the present preferred embodiment, white illumination of various hues can be accomplished using a single module.

] Moreover, in the illumination device of the present preferred embodiment, lighting and extinguishing control of the first light-emitting element LED 1 and second light-emitting element LED 2 is performed so that the total of the “on” duty of both light-emitting elements is 100%. Accordingly, even if the ratio of the lighting period T1 of the first light-emitting element LED 1 and the lighting period T2 of the second light-emitting element LED 2 within the lighting period Ton is variably controlled, the device is constantly lit as viewed from the total lighting period Ton. Consequently, the brightness of the illuminating light can be maintained at a constant value.

Furthermore, chromaticity adjustment of the illuminating light can also be performed using a construction in which one of the light-emitting element LEDs, i.e., the first light-emitting element LED 1 or second light-emitting element LED 2, is constantly lit, and only the “on” duty of the other light-emitting element LED is varied (in other words, a construction in which the “on” duty of the first light-emitting element LED 1 and second light-emitting element LED 2 is not maintained at a total of 100%). However, in the case of such a construction, the adjustment range of the chromaticity is narrowed, and the brightness of the illuminating light cannot be maintained at a constant value. Accordingly, it is desirable to use the construction of the preferred embodiment described above.

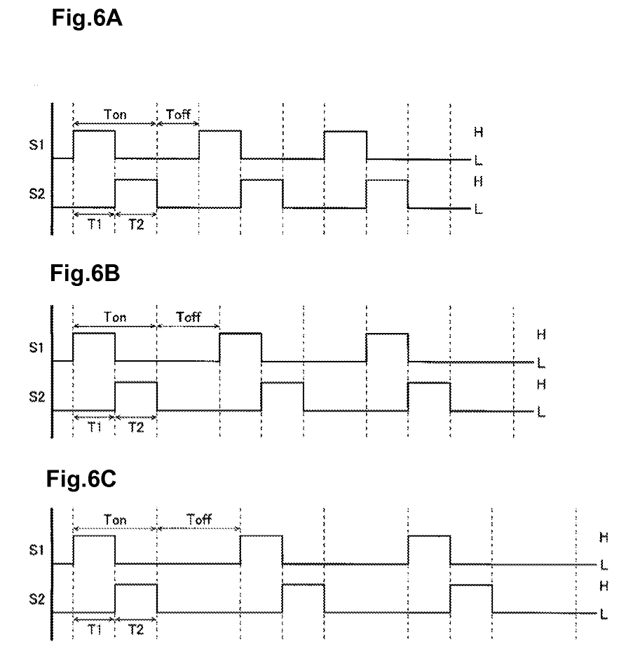

Next, the brightness adjustment operation of the illuminating light performed by the control circuit CTRL will be described in detail with reference to FIGS. 6A-6C.

FIGS. 6A-6C are diagrams illustrating one example of the brightness adjustment operation of the illuminating light. The symbols S1 and S2 in FIGS. 6A-6C respectively indicate the logical states of the switching control signals S1 and S2 (and by extension, the lit and extinguished states of the LED 1 and LED 2).

As is shown in FIGS. 6A-6C, the control circuit CTRL has a construction which maintains the length of the lighting period Ton at a constant value, and which variably controls the length of the extinguishing period Toff in accordance with brightness control signals.

To describe this in more specific terms, in cases where the brightness of the illuminating light is to be lowered, the extinguishing period Toff may be made successively longer (FIG. 6A→FIG. 6B→FIG. 6C); conversely, in cases where the brightness of the illuminating light is to be raised, the extinguishing period Toff may be made successively shorter (FIG. 6C→FIG. 6B→FIG. 6A).

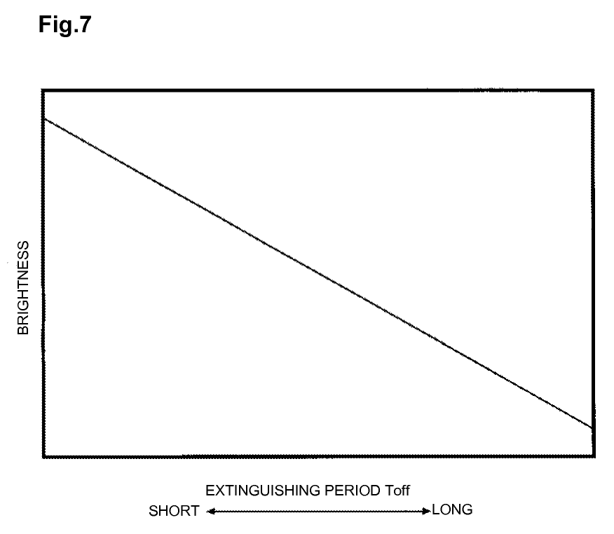

FIG. 7 is a diagram illustrating the variation in the brightness in accordance with the length of the extinguishing period Toff.

As is shown in this figure, the brightness of the illuminating light is lowered as the length of the extinguishing period Toff increases; conversely, the brightness of the illuminating light becomes higher as the length of the extinguishing period Toff becomes shorter.

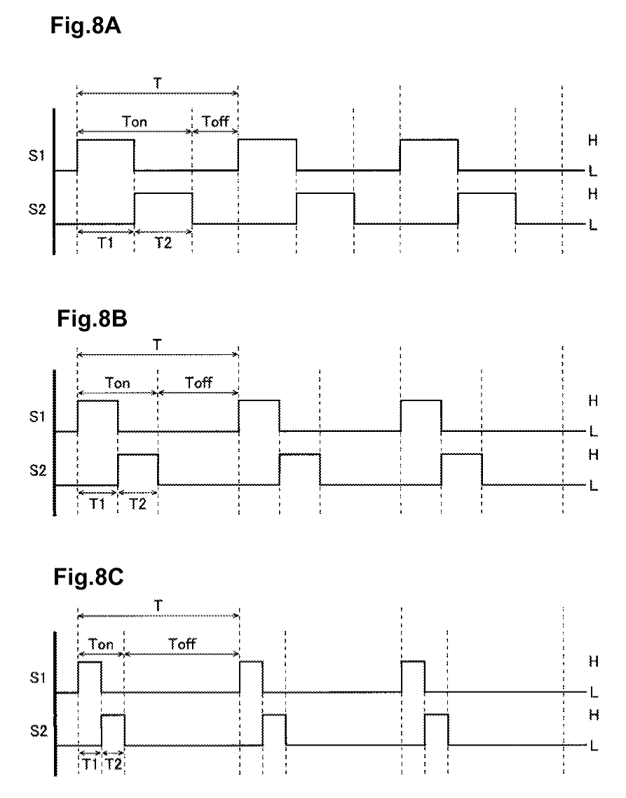

FIGS. 8A-8C are diagrams illustrating another example of the brightness adjustment operation of the illuminating light. The symbols S1 and S2 in FIGS. 8A-8C respectively indicate the logical states of the switching control signals S1 and S2 (and by extension, the lit and extinguished states of the LED 1 and LED 2).

As is shown in FIGS. 8A-8C, the control circuit CTRL has a construction which variably controls the ratio of the lighting period Ton and the extinguishing period Toff within a specified lighting and extinguishing period T in accordance with brightness control signals.

To describe this in more specific terms, in cases where the brightness of the illuminating light is to be lowered, the ratio of the lighting period Ton with respect to the lighting and extinguishing period T (the total “on” duty combining the first light-emitting element LED 1 and second light-emitting element LED 2) may be successively lowered (FIG. 8A→FIG. 8B→FIG. 8C); conversely, in cases where the brightness of the illuminating light is to be raised, the total “on” duty may be successively raised (FIG. 8C→FIG. 8B→FIG. 8A).

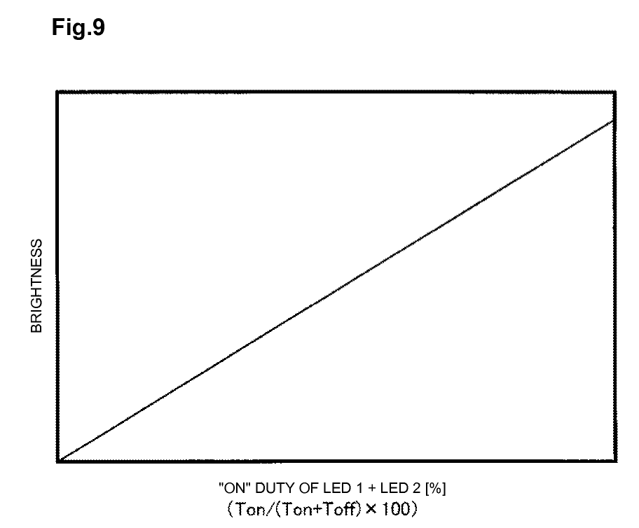

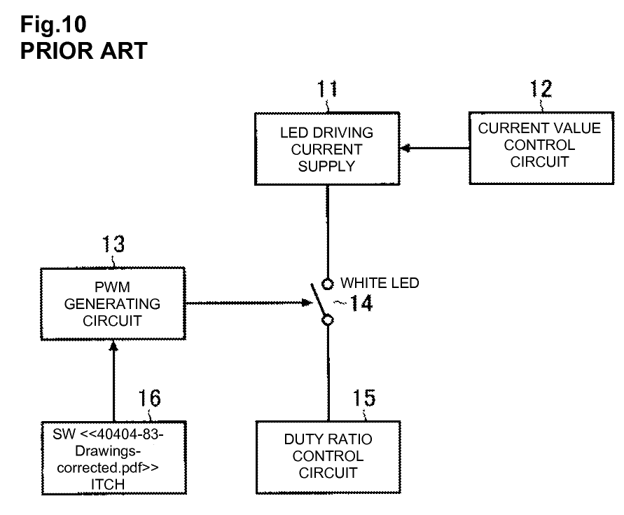

FIG. 9 is a diagram illustrating the variation in the brightness corresponding to the ratio of the lighting period Ton with respect to the lighting and extinguishing period T.

As is shown in this figure, the brightness of the illuminating light is lowered with a decrease in the total “on” duty; conversely, the brightness of the illuminating light increases with an increase in the total “on” duty.

Furthermore, with regard to the lighting and extinguishing period T described above, it is desirable to set this period at a length (around several hundred ms) which is such that there is no sense of flickering as seen by the naked eye.

As was described above, the illumination device according to a preferred embodiment of the present invention is an illumination device preferably including a first light-emitting element LED 1 and a second light-emitting element LED 2 having mutually different color temperatures, and a control circuit CTRL which performs lighting and extinguishing control of the first light-emitting element LED 1 and second light-emitting element LED 2, with this control circuit CTRL having a construction which performs lighting and extinguishing control of the first light-emitting element LED 1 and second light-emitting element LED 2 so that this control has a lighting period Ton in which the first light-emitting element LED 1 and second light-emitting element LED 2 are lit and extinguished in a complementary manner, and an extinguishing period Toff in which both the first light-emitting element LED 1 and second light-emitting element LED 2 are extinguished.

By using such a construction, it is possible to arbitrarily adjust the chromaticity of the illuminating light without any effect on the brightness of the illuminating light by appropriately selecting the ratio of the lighting period T1 of the first light-emitting element LED 1 and the lighting period T2 of the second light-emitting element LED 2 within the lighting period Ton. Furthermore, it is possible to arbitrarily adjust the brightness of the illuminating light without any effect on the chromaticity of the illuminating light by appropriately selecting the length of the extinguishing period Toff, or the ratio of the lighting period Ton and the extinguishing period Toff within the lighting and extinguishing period T. Moreover, because the chromaticity control and brightness control of the illuminating light according to a preferred embodiment of the present invention are not accompanied by driving current control of the first light-emitting element LED 1 and second light-emitting element LED 2, the control in the control circuit CTRL can be realized in a simple manner.

With regard to the construction according to the present invention, furthermore, besides the preferred embodiments described above, various alterations may be added in a range that involves no departure from the gist of the invention. For example, field effect transistors may be used instead of the bipolar transistors N1 and N2 in FIG. 1. Moreover, a constant current source may be used instead of the resistors R1 and R2 in FIG. 1.

Preferred embodiments of the present invention provide a technique that is suitable for use in common illumination devices used in various types of applications, beginning with the backlighting of liquid crystal displays.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. An illumination device comprising:
a first light-emitting element;
a second light-emitting element having a different color temperature than the first light-emitting element; and
a control circuit that is arranged to perform lighting and extinguishing control of the first light-emitting element and second light-emitting element; wherein
said control circuit is arranged to perform periodic lighting and extinguishing control of the first light-emitting element and second light-emitting element such that, during a lighting period, the first light-emitting element and second light-emitting element are lit and extinguished in a complementary manner, and during an extinguishing period, the first light-emitting element and second light-emitting element are both extinguished.

2. The illumination device according to claim 1, wherein said control circuit variably controls a ratio of the lighting period of the first light-emitting element and the lighting period of the second light-emitting element within said lighting period in accordance with chromaticity control signals.

3. The illumination device according to claim 1, wherein said control circuit variably controls a length of said extinguishing period in accordance with brightness control signals while maintaining a length of said lighting period at a constant value.

4. The illumination device according to claim 1, wherein said control circuit variably controls a ratio of said lighting period and said extinguishing period within a specified lighting and extinguishing period in accordance with brightness control signals.

5. The illumination device according to claim 1, wherein each of the first light-emitting element and second light-emitting element includes a blue light-emitting diode that emits blue light and a fluorescent layer that covers said blue light-emitting diode, and said fluorescent layer includes a uniformly mixed red fluorescent body and green fluorescent body that are excited by blue light and that respectively emit red light and green light with a transparent resin, or uniformly mixed yellow fluorescent body that is excited by blue light and that emits yellow light with a transparent resin.
